(19) United States
(12) Patent Application Publication
(10) Pub. No.: US 2011/0009194 A1
(43) Pub. Date: Jan. 13, 2011

(54) ACOUSTIC MOTION CAPTURE

(76) Inventors: Oz Gabai, Tel Aviv (IL); Haim Primo, Gane-Tikva (IL)

Correspondence Address: DANIEL J SWIRSKY, 55 REUVEN ST., BEIT SHEMESH, 99544, IL

(21) Appl. No.: 12/746,532

(22) PCT Filed: Dec. 4, 2008
(86) PCT No.: PCT/IL08/01578

§ 371 Date: Aug. 1, 2010

Related U.S. Application Data
(60) Provisional application No. 61/012,001, filed on Dec. 6, 2007.

(51) Int. Cl. A63F 13/06

(52) U.S. Cl. 463/36

(57) ABSTRACT

A motion-capture system containing a base-unit and one or more mobile-articles The base-unit contains two or more acoustic transmitters, each transmitting an acoustic signal, an RF transmitter transmitting a synchronization signal, and an RF receiver for receive timing data transmitted from the mobile-articles. The synchronization signal and the acoustic signals are transmitted synchronously, and the timing data contains time measuring information associated with time delay at the mobile-article, between the synchronization signal and the acoustic signals.

### CROSS-REFERENCE TO RELATED APPLICATIONS

The present application claims priority from U.S. provisional patent application 61/012,001 filed Dec. 6, 2007, the contents of which are hereby incorporated by reference.

### FIELD AND BACKGROUND OF THE INVENTION

The present invention relates to motion-capture systems and methods, and, particularly, to motion-capture used for video animation, and/or to motion-capture used at home environment, and/or to a motion-capture system used as a peripheral of a home computer or a video game console.

The term motion-capture relates to methods of translating the motions of a human subject to an animated image. A typical motion-capture system includes a system that tracks certain motions performed by the human subject, and software that controls a visual image presenting the tracked motions. The technology used by the motion-capture system, the extension of the motions that may be tracked, and the quality of the visual representation of the tracked motions, vary considerably according to the application for which the motion-capture solution is designed.

The two principal branches of motion-capture applications are:
The animation film industry and professional game development;
The video games market, which includes the domestic and the arcade segments. The domestic segment is further segmented into video game consoles, handheld consoles, and video game software for the home computer.

The prevailing motion-capture solutions are divided into two distinct classes according to the abovementioned principal application branches.
High-quality motion capture systems designed for professionals in the animation film and game development industries; and
Elementary motion-capture solutions for personal game and Arcade systems.

However, each of these classes of products falls short of allowing the inclusion of extended motion-capture capabilities in video game systems for the private consumer.

Current motion-capture technologies include optical, inertial and magnetic-field, which are often combined in hybrid products. These professional products employ sophisticated sensor-detector systems with a high sampling rate, and rely on extensive setup and controlled conditions, which are indeed feasible only for professional purposes.

Optical systems based on a set of cameras and appropriate sensors that are mounted on a physical subject require highly complicated and costly equipment.

Inertial technology based on gyroscopes and accelerometers mounted on a subject requires heavy equipment and complicated setup and calibration procedures.

Systems that employ magnetic field technology are sensitive to ambient disturbances, a limitation that renders them inapplicable to residential surroundings.

Examples of professional motion-capture system include the IS-900 system by Intersenses, MotionStar Wireless®2 and Resubject2 by Ascension-Tech.

Current professional motion-capture solutions involve heavy equipment, tiresome calibration and setup processes, sensitivity to various types of interference, and, above all, high costs, due to which these solutions are fundamentally inapplicable for mass production and for the private consumer.

For residential use, the most common motion-capture solutions that are currently available in the video game field, introduced by both Sony and Microsoft, employ a rather simple optical motion-gesture method. This solution provides only elementary motion tracking capability by means of a single, low-cost camera, allowing a user to control the movement of an image on a screen. This solution enables the use of body motions to replace a joystick, and while clearly showing the trend of the market it falls short of providing significant tracking capabilities. A single camera can track motion in only two dimensions. Also lacking in this simple and insufficient solution is the firing function whose omission is significant in the case of the greater part of the most popular games. This simple optical system is also unable of tracking fast motions, as desired by video game applications and system.

Another motion-capture solution provided by Nintendo's Wii game console includes a handheld unit allowing three-dimensional motion tracking. While providing a firing function and moving slightly beyond rudimentary gesture-motion, this solution is still severely limited in comparison with a full-body motion-capture system as it is limited to tracking a single motion per game-console unit.

The motion tracking capabilities of current arcade systems are also fundamentally insufficient being unable of tracking fast motions, and being unable of tracking specific body parts.

In fact, there is currently no high-quality motion-capture solution for personal video game systems. The lack of such a solution is significant given the recent trend in the video game field which obviously points in the direction of including a motion-capture element of some sort for the new generation game devices. And while all recent releases by the three principal competitors in the field—Sony, Microsoft and Nintendo—include but elementary motion capture features, the advantage of including motion-capture capabilities of higher quality is obvious.

Motion capture greatly enhances the fun of a game activity and turns it into a much more fascinating experience. The scene of a detached game user hooked to the home computer (PC) is replaced by a free motion experience, which appeals not only to the participants themselves but also to their spectators.

There is thus a widely recognized need for, and it would be highly advantageous to have, a motion-capture system devoid of the above limitations.

### SUMMARY OF THE INVENTION

According to one aspect of the present invention there is provided a motion-capture base-unit for detecting a motion-capture mobile-article, the base-unit including two or more acoustic transmitters, each operative for transmitting an acoustic signal, an RF transmitter operative to transmit a synchronization signal, and an RF receiver operative to receive timing data transmitted from the mobile-article, where the synchronization signal and the acoustic signals are transmitted synchronously, and the timing data contains time measuring information associated with time delay at the mobile-article between the synchronization signal and the acoustic signals.

According to another aspect of the present invention there is provided a motion-capture base-unit additionally including a communication unit operative to connect the base-unit with a computer.

According to yet another aspect of the present invention there is provided a motion-capture base-unit where the timing data contains a plurality of maxima points of the acoustic signals measured at the mobile-article.

According to still another aspect of the present invention there is provided a motion-capture base-unit where the communication unit includes at least one of a wired communication technology and a wireless communication technology.

Also according to yet another aspect of the present invention there is provided a motion-capture base-unit where the base-unit is operative to communicate motion-capture information of the mobile-article via the communication unit to the computer.

Further according to another aspect of the present invention there is provided a motion-capture base-unit where the motion-capture information includes at least one of location of at least one of the mobile-articles, orientation of at least one of the mobile-articles, motion direction of at least one of the mobile-articles, motion speed of at least one of the mobile-articles, status information of the actuating key of at least one of the mobile-articles, and location of the base-unit.

Yet further according to another aspect of the present invention there is provided a motion-capture base-unit where the motion-capture information includes three-dimensional data.

According to another aspect of the present invention there is provided a motion-capture mobile-article for detecting the location of the mobile-article with respect to a base-unit, the mobile-article including at least one acoustic receiver, each operative for receiving an acoustic signal transmitted from the base-unit, an RF receiver operative to receive a synchronization signal transmitted from the base-unit, and an RF transmitter operative to transmit timing data to the base-unit, where the synchronization signal and the acoustic signals are transmitted synchronously, and the timing data contains time measuring information associated with time delay at the mobile-article between the synchronization signal and the acoustic signals.

According to yet another aspect of the present invention there is provided a motion-capture mobile-article where the detection of the article includes at least one of location, orientation, motion direction and motion speed of the mobile-article.

According to still another aspect of the present invention there is provided a motion-capture mobile-article additionally including a correlator module operative to identify the acoustic signals, a local maxima processor operative to identify maxima points of the received acoustic signals, and a processor for creating timing data.

Also according to another aspect of the present invention there is provided a motion-capture mobile-article additionally including a digital signal processor (DSP), a plurality of acoustic chains, each acoustic chain including an acoustic transducer, an acoustic pre-amplifier and filters module, and a programmable gain amplifier, and an analog to digital array.

Additionally according to another aspect of the present invention there is provided a motion-capture mobile-article additionally including a power supply manager including a motion sensor for shutting down power supply once the mobile article is still for a time-out period, and a time-out counter for measuring the time-out period.

Further according to another aspect of the present invention there is provided a motion-capture mobile-article where the article is attached to a human subject and where the base station is operative to detect at least one of location, orientation, motion direction and motion speed of the human subject.

Yet further according to another aspect of the present invention there is provided a motion-capture mobile-article where the article is attached to a body part of a human subject and where the base station is operative to detect at least one of location, orientation, motion direction and motion speed of the mobile body part of human subject.

Still further according to another aspect of the present invention there is provided a motion-capture mobile-article where the article additionally includes a strap to be fastened to the body-part.

Even further according to another aspect of the present invention there is provided a motion-capture mobile-article where the article additionally includes at least one actuating key, and where the timing data additionally include status information of the actuating key.

According to yet another aspect of the present invention there is provided a motion-capture mobile-article where the actuating key includes an electric switch.

According to still another aspect of the present invention there is provided a motion-capture mobile-article additionally operative as at least one of a joystick, a computer's pointing device, and as a remote control for at least one of a television and a set-top-box.

Also according to still another aspect of the present invention there is provided a motion-capture mobile-article additionally operative to perform at least one of effect menu selection, and animate a visual object.

Also according to yet another aspect of the present invention there is provided a motion-capture mobile-article where the timing data includes correlation of the acoustic signal.

Further according to yet another aspect of the present invention there is provided a motion-capture mobile-article where the timing data is calculated from, or includes, a sequence of a predefined number of maxima points of the acoustic signals.

Yet further according to another aspect of the present invention there is provided a motion-capture mobile-article where the predefined number of maxima points is based on multiplication of Aₜₓ by Aᵣₓ, where Aₜₓ is the number of the acoustic transmitters, and where Aᵣₓ is the number of the acoustic receivers.

Still further according to another aspect of the present invention there is provided a motion-capture mobile-article where the timing data is sent to the base-unit for each acoustic signal received from each acoustic transmitter, and where the timing data is transmitted sequentially using Time Division Multiple Access (TDMA).

Even further according to another aspect of the present invention there is provided a motion-capture mobile-article where the timing data is sent to the base-unit for each acoustic signal received from each acoustic transmitter, and where the timing data is transmitted sequentially using TDMA.

Additionally according to another aspect of the present invention there is provided a motion-capture mobile-article where the timing data includes forward error correction code (FEC).

Also according to yet another aspect of the present invention there is provided a motion-capture mobile-article where the FEC includes Reed-Solomon (RS) code.

Also according to yet another aspect of the present invention there is provided a motion-capture mobile-article additionally including motion sensor and where the mobile-article is operative to switch between operation and stand-by modes according to measurement provided by the motion sensor.

Additionally according to still another aspect of the present invention there is provided a motion-capture base-unit where motion-capture information includes at least one of location of at least one of the mobile-articles, orientation of at least one of the mobile-articles, motion direction of at least one of the mobile-articles, motion speed of at least one of the mobile-articles, status information of the actuating key of at least one of the mobile-articles, and location of the base-unit.

Further according to still another aspect of the present invention there is provided a motion-capture base-unit where the acoustic signals are each coded at the base-unit for identification of the acoustic signal at the mobile-article.

Yet further according to another aspect of the present invention there is provided a motion-capture base-unit where the coding of the acoustic signals includes code-division sequences.

Also according to still another aspect of the present invention there is provided a motion-capture system where the timing data includes clock signal, packet length identifier, forward error correction (FEC) data, path delays information, and CRC.

Also according to still another aspect of the present invention there is provided a motion-capture system where the path delay information includes path delta time measured from a reference delay to path data, and path amplitude.

Further according to yet another aspect of the present invention there is provided a method of motion-capture including providing a base station performing the steps of transmitting an RF signal for synchronization, transmitting a plurality of acoustic signals for localization, receiving timing data from a mobile-article, performing localization of the mobile article to form localization data, and sending the localization data to a host computer.

Further according to yet another aspect of the present invention there is provided a method of motion-capture including providing a mobile-article performing the steps of receiving RF signal transmitted by a base-unit for synchronization, receiving a plurality of acoustic signals transmitted by the base-unit for localization, correlating the acoustic signals to identify at least one path of the acoustic signals, selecting at least one of the paths. creating timing data packet including information of the selected paths, and transmitting the timing data to the base-unit.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of a motion-interactive system;

FIG. 2 a simplified and more detailed illustration of a base-unit of the motion-interactive system connected to a computing device;

FIGS. 3A, 3B and 3C are simplified illustrations of mobile-articles of the motion-interactive system worn by a human subject;

FIG. 4A and FIG. 4B are, respectively, a simplified illustration of an animated figure displayed on a screen, and is a simplified illustration of a human subject, using hand mobile-articles to animate the figure;

FIG. 5 is a simplified schematic illustration of communication channels between the base-unit and the mobile article;

FIG. 6 is a simplified timing diagram of RF and acoustic signals flowing within the motion-capture system;

FIG. 7 is a simplified schematic diagram of the motion-capture system 13 equipped with a plurality of mobile-articles;

FIG. 8 is a simplified flowchart of an operation scenario of the motion-capture system;

FIG. 9 is a simplified diagram of power delay profile for a frame of the motion-capture system;

FIG. 10 is a simplified diagram of power delay profile showing maxima points;

FIG. 11 is a simplified schematic diagram of a TDMA process for transmitting timing data from the mobile-article to the base-unit;

FIG. 12 is simplified block-diagram illustration of a mobile-article;

FIG. 13 is a simplified diagram of a power delay profile in a motion-capture system;

FIG. 14 is a simplified block-diagram illustration of a base-unit;

FIG. 15 is a diagram of a minimum SNR power delay profile;

FIG. 16 is a simplified time-flow of a sequence transmission in the motion-capture system;

FIG. 17 is a simplified block diagram of the timing data;

FIG. 18 is a simplified block diagram of a localization algorithm performed by the motion-capture system;

FIG. 19 is a simplified flowchart of a background procedure of the mobile-article;

FIG. 20 is a simplified flowchart of a foreground procedure of the mobile-article;

FIG. 21 is a simplified flowchart of a background procedure of the base-unit; and

FIG. 22 is a simplified flowchart of a foreground procedure of the base-unit.

### DESCRIPTION OF THE PREFERRED EMBODIMENTS

The principles and operation of a motion-capture system and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The motion-capture system of the present invention is intended to overcome limitations of the systems currently known in the art. The novel type of system that is proposed here is designed to provide a full-body, high quality motion capture solution that would be technically applicable to a private home setting and affordable for the average private consumer. Bearing in mind the state of the art in the motion-capture field, our solution offers the following clearly pronounced advantages.

The motion-capture system of the present invention system provides high-quality motion-capture capabilities based on tracking three-dimensional position of multiple points with a high sampling rate. This allows smooth capturing of fast motion of distinct body parts, and of the entire body of a user, or even a number of users simultaneously. The system also provides a firing function whose omission in some of the existing solutions proves to be a significant drawback for video game purposes.

These features, which practically match those of the most professional motion-capture solutions, are attained by means of light equipment which is strictly applicable to a private home setting and answers the expectations of private consumer of video game products. Unlike most of the professional motion-capture systems, our system involves no tedious setup, requiring neither heavy wiring of sensors upon a user, nor the installation of sensitive receptors. The system does not require calibration or training process, and avoids the sensitivity to ambient disturbances, which limit the use of professional motion-capture solutions to controlled conditions.

Additionally, the system features easy connectivity and applicability to the most popular among the currently prevailing game devices. It allows connection to the joystick port of game consoles such as Sony Playstation or to the standard PC USB port. As a result, the system is applicable to all forms of current generation video games while at the same time provides an opportunity to develop new and more fascinating games to match its extended motion-capture features.

Given the above-mentioned advantages, the most striking feature of the system is its low cost and affordability for the private consumer. The system's structure and components are suitable for mass production and marketing.

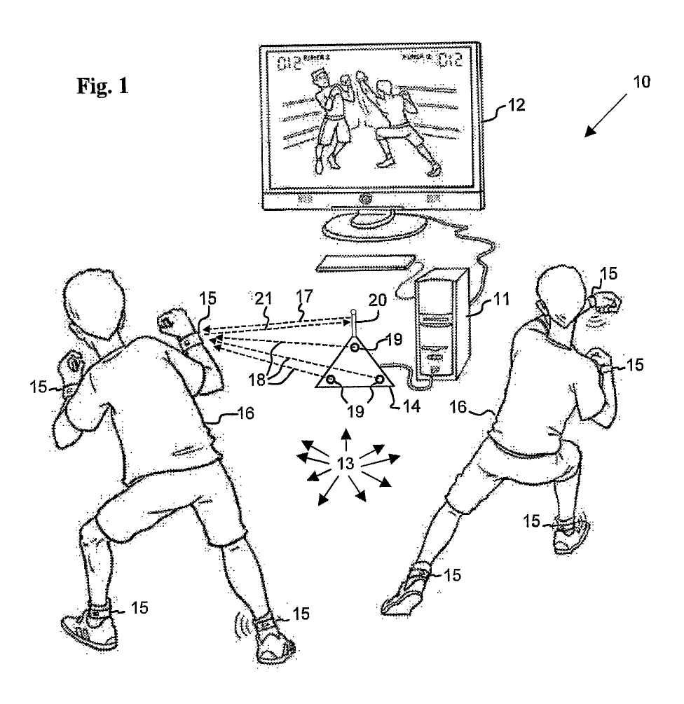

Reference is now made to FIG. 1, which is a simplified illustration of a motion-interactive system 10 according to a preferred embodiment of the present invention.

Motion-interactive system 10 preferably includes a computing device 11 connected to a display 12 and to a motion-capture system 13. The computing device 11 can be a computer, such as a home computer, a laptop computer, a home entertainment server, etc., a video game console, a television set-top-box, etc.

The motion-capture system 13 is preferably operative as a peripheral the computing device 11 and preferably connectable as a plug-and-play device. The motion-capture system 13 preferably includes a base-unit 14 and one or more mobile (and mobile) articles 15. The mobile articles 15 are preferably held by or attached to one or more human subjects 16. As seen in FIG. 1, four mobile articles 15 are attached to the wrists of two human subjects 16.

Preferably, the base-unit 14 transmits a fast-travelling synchronization signal 17 and a plurality, preferably three, slow-travelling positioning signals 18.

Preferably, the fast-travelling synchronization signal 17 is a radio frequency (RE) signal, but it can also be an infra-red (IR) signal or any other electromagnetic signal.

The low-travelling positioning signals 18 are preferably audio or acoustic or ultra-sound signals. Hereinafter, slow-travelling signals, positioning signals, acoustic positioning signals, and acoustic signals, whether using sub-audio, audio, or ultra-sound frequencies, refer to the same type of signals, as designated in FIG. 1 by numeral 18. Typically, the acoustic signal frequency is about 40,000 Hz.

As seen in FIG. 1, the motion-capture base-unit 14 includes three acoustic transmitters 19, each operative for transmitting the acoustic signal 18 and an RF transceiver connected to antenna 20 and operative to transmit the synchronization signal 17. The motion-capture base-unit 14 also includes an RF receiver, also connected to antenna 20, and operative to receive timing data 21 transmitted from the mobile-articles 15.

For simplicity of the illustration, FIG. 1 shows synchronization signals 17, acoustic signals 18 and timing data 21 are shown between the base-unit 14 and one mobile article 15. However, it may be understood that the synchronization signals 17, the acoustic signals 18 are received by all the mobile articles 15, and that each of the mobile articles 15 transmits timing data 21 to the base-unit 14.

Preferably, the base-unit 14 transmits the synchronization signal 17 and the acoustic signals 18 synchronously. Preferably, the timing data 21 for each mobile article 15 contains time measuring information associated with time delay at the mobile-article 15, between the synchronization signal 17 and each of the acoustic signals 18.

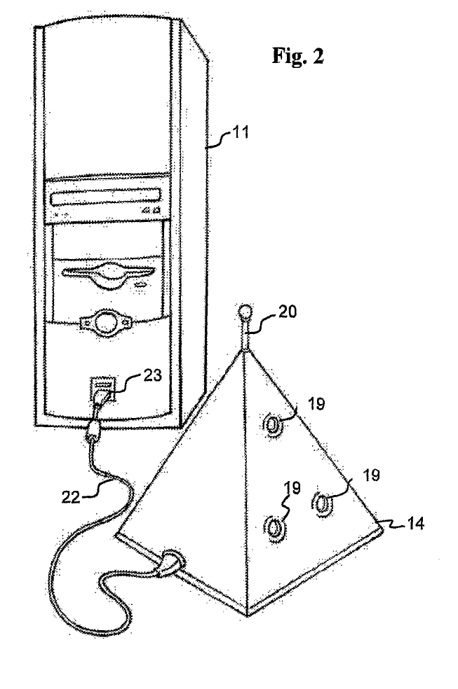

Reference is now made to FIG. 2, which is a simplified and more detailed illustration of the base-unit 14 connected to the computing device 11 according to a preferred embodiment of the present invention.

As seen in FIG. 2, the base-unit 14 is preferably connected to the computing device 11 via a USB connection 22. The pyramid-shaped base-unit contains a plurality of acoustic transmitters 19, three acoustic transmitters 19 in the preferred example of FIG. 2. The acoustic transmitters 19 are preferably mounted on one of the pyramid's inclined sides. An antenna 20 of a radio transceiver is mounted at the top of the pyramid. The base-unit 14 connects to the computing device 11 via a USB port 23, and following an initial installation functions as a plug-and-play device requiring no further setup procedure.

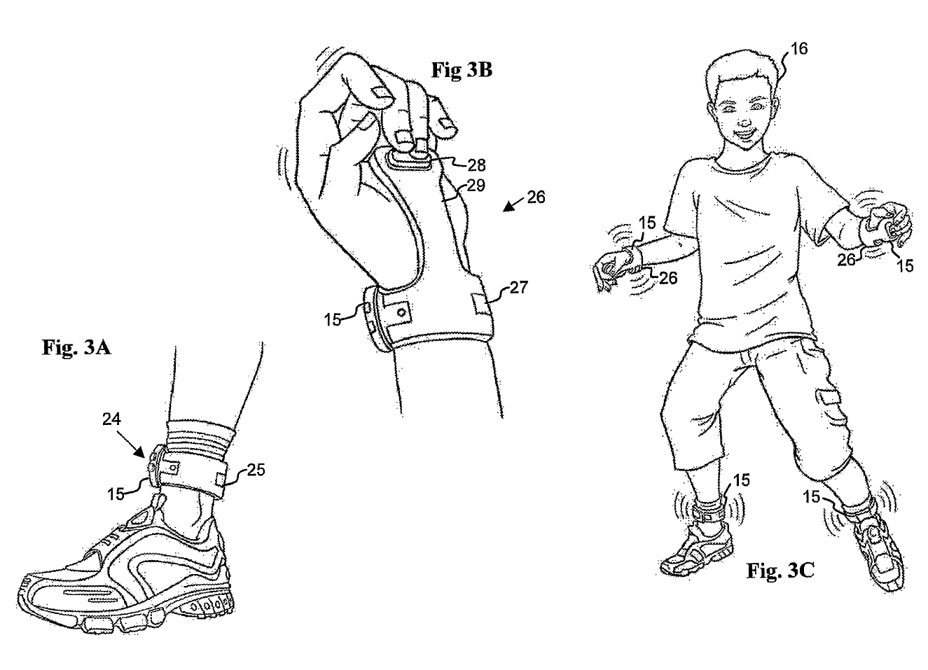

Reference is now made to FIGS. 3A, 3B and 3C, which are simplified illustrations of mobile articles 15 worn by a human subject, according to a preferred embodiment of the present invention.

FIG. 3A shows a leg mobile-article 24, preferably including a mobile article 15 preferably mounted on a strap 25, preferably worn on a leg of a human subject. As shown in FIG. 3A, the leg mobile-article 24 is worn just above the ankle.

FIG. 3B shows a hand mobile-article 26 containing a mobile article 15 preferably mounted on a bracelet 27, preferably worn on a hand of a human subject. As seen in FIG. 3B, is preferably equipped with an actuating key 28, preferably mounted on a control handle 29 held in the palm of the user.

It is appreciated that the hand mobile-article 26 can be equipped with a plurality of actuating keys, or an actuating key operating a plurality of electrical switches, as seen in FIG. 3B.

It is appreciated that the hand mobile-article 26 can include two or more mobile articles 15, for example to enable measuring the orientation of the hand mobile-article 26.

FIG. 3C shows a human subject 16 wearing four mobile articles 15, a hand mobile-article 26 on each hand and a mobile article 15 on each leg.

The function of an acoustic motion-capture system utilizing RF synchronization method in accordance with a preferred embodiment of the present invention is now described. Immediately upon connection to a computer or a game-console, the base of FIG. 1 transmits radio signals to any of the system's motion sensors in its vicinity, activating the sensors in a synchronized manner to receive acoustic signals, and to transmit positioning data using their RF transceiver back to the base, thereby to track their respective three-dimensional locations in real-time. These real-time locations are then fed as input data to any game software on the computer.

Referring to FIGS. 1, 2 and 3A-3C, it is seen that the acoustic signals transmitted by the three acoustic transmitters 19 of the base-unit 14 are received after respective delays by each of the acoustic receivers (not shown) of the mobile articles 15. Each mobile article 15 measures the time of arrival of the acoustic signals with respect to the time of arrival of the RF signal, and calculates the exact delay using correlation. Each mobile article 15 then transmits the timing information, containing the results of the delay calculations, to the base-unit 14, using its RF transceiver (not shown). This information enables the base-unit 14 to calculate accurate, virtually real-time, location data for each of the mobile articles 15.

The radio RF transceiver on the mobile article 15 communicates with the radio RF transceiver on the base-unit 14 for the purpose of synchronizing the acoustic signals, thereby correlating acoustic signals received from plurality of acoustic transmitters 19.

The radio transceiver of the mobile article 15 also transmits to the base-unit 14 signals indicating the activation status of the two buttons (actuating keys 28) on the control handle 29, thereby providing a selection function such as a menu selection function, and/or an activation function such as a firing function for action games.

Including at least one acoustic receiver and a radio transceiver, the leg mobile-article 24 communicates with the base-unit 14, thereby allowing real-time tracking of the accurate location of the user's leg.

The set of mobile article 15, preferably including two hand mobile-article 26 and two leg mobile-article 24 wrapped respectively around the user's hand joints and ankles, and communicating in a synchronized manner with the base-unit 14, provide accurate real-time locations of the user's hands and legs. Additionally, a software model of the human body that runs on the base-unit 14 platform rounds out these four locations data, thereby feeding computer games or animation software with approximate full-body motion data.

It is appreciated that the system of FIGS. 1, 2 and 3A-3C, which contains the bracelet-shaped mobile article 15 with its control handle 29 and the base-unit 14 with which it communicates, can rather elegantly replace the function of a joystick in current-generation games. Combining hand motions and activation of buttons which are captured in real-time, the user can easily feed a computer game system with any input data that may be produced by a joystick. With animated images carrying weapons of various kinds, as is the case of many action games, the use of hand motion as a pointing method is much more natural than the joystick which is rooted in the imagery of aircrafts and spaceships.

It is appreciated that the system of FIGS. 1, 2 and 3A-3C, allows a user to fully control and animate a variety of video images such as action game images, images from a world of fantasy, martial art images and images simulating gymnastic exercises.

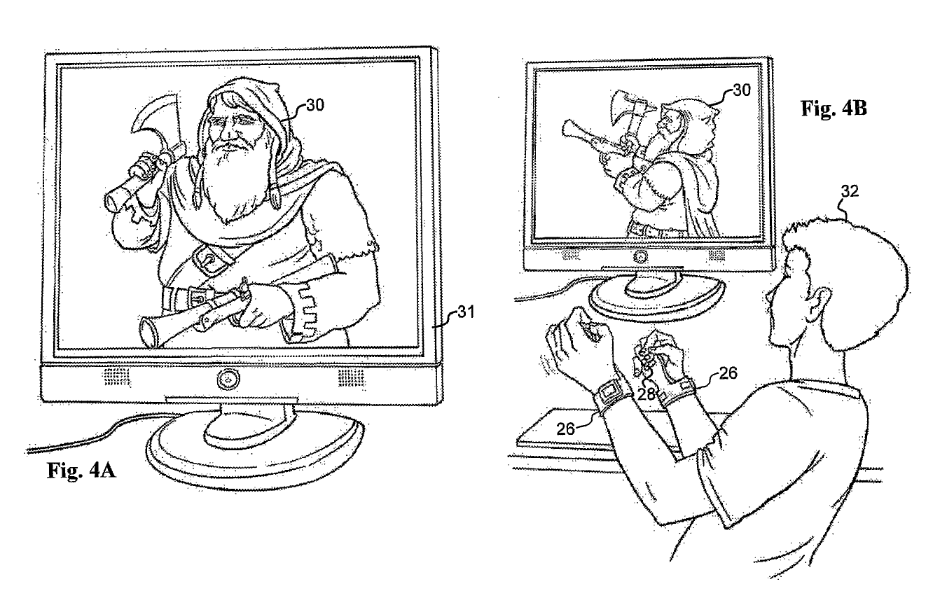

Reference is now made to FIG. 4A, which is a simplified illustration of an animated FIG. 30 displayed on a screen 31, and to FIG. 4B, which is a simplified illustration of a human subject 32, using hand mobile-articles 26 to animate the FIG. 30, according to a preferred embodiment of the present invention.

It is appreciated that the screen 31 can be a computer screen, a laptop screen, a television screen typically connected to a video game console, etc.

As seen in FIG. 4A, the computer screen shows an image of a dwarf armed with both an ax and a rifle, one of the typical images of a world of fantasy engaging in combats with monsters and other evil creatures which inhabit this fantasy world. It is appreciated that the motion-capture system 13 shown and described with reference to FIGS. 1, 2 and 3A-3C, allows a user to animate this dwarf image by means of motions of the user's both hands as well as by activating the control buttons (actuating keys 28) on hand mobile-articles 26. For example, actuating keys 28 can be used to invoke firing, and/or to replace the weapons with which the dwarf is currently armed with other types of weapon as often occurs in such action and fantasy games.

As seen in FIG. 4B, the dwarf image 30 on the screen 31 assumes the same posture as the human subject (user) 32. The human subject 32 controls the image and animates it by means of both hand and leg motions, as well as control buttons on the hand mobile-articles 26. A human body software model is employed to round out the location data of the user's hands and legs into full-body posture which is provided as input data to the game animation software.

It is appreciated that similarly to the functionality of FIGS. 4A and 4B, a user may animate a great variety of images for the purpose of most varied games including images of adventure games, dancing images, historical images and many more. The inclusion of extensive motion-capture capability within a game system is also ideal for sports and gymnastics games, turning a gym session into a pleasurable diversion, allowing for networked games to be played in a gym or across remote locations.

The functionality of the motion-capture system 13 in accordance with a preferred embodiment of the present invention is now described.

Motion Capture is a process that allows generating human motion data. The motion-capture system 13 is using acoustic and radio technologies to gather the motion data. The base-unit 14 includes a sophisticated signal processing engine (sensor array processor), and is connected to a home computer (PC) or a game console while the user is wearing mobile articles 15 on various body parts. When the player (e.g. user, human subject) is moving, the system analyzes in real time the ID and position of each of the mobile articles 15 accurately and at a fast update rate. The resulting motion data is a stream of numbers representing the absolute 3D-position of the mobile articles 15, in reference to the base-unit 14. This motion data is then transferred in real-time to the PC or the Game console.

The motion-capture system 13 provides high-quality motion-capture capabilities based on tracking three-dimensional position of multiple points with a high sampling rate. This allows capturing smooth and fast motions of distinct body parts, or the entire body motion of a user, or even a number of users simultaneously.

As shown and described above, the motion-capture system 13 is based on a fixed base-unit 14, which includes at least three acoustic transmitters 19 and an RF transceiver, and plurality of wearable mobile articles 15. The motion-capture is performed as a series of localization of each of the mobile articles 15.

The localization is performed by transmitting an RF marker in parallel to code separated acoustic signal. The RF marker signal (the synchronization signals 17 of FIG. 1) and the code separated acoustic signals (the positioning signals 18 of FIG. 1) are received by each of the mobile articles 15. Each of the mobile articles 15 calculates the exact time of travel of the acoustic signals from each of the transmitters 19 of the base-unit 14 to each of the acoustic receivers of the mobile articles 15. The calculation is done by comparing the time of arrival of the acoustic signals with the time of arrival of the RF marker signal as the mobile articles 15 and by using correlation.

Each of the mobile articles 15 transmits motion information (timing data 21 of FIG. 1) back to the base-unit 14 using the RF transceiver. The base-unit 14 then uses each of these 3-delays sets (timing data 21), to calculate the exact 3D location of each one of the mobile articles 15, relative to the 3D position of the base-unit 14.

The localization process is based on the following algorithm:
An RF marker is periodically transmitted every 1 msec.
In parallel to the RF signal, at least three acoustic transmitters (using low 40 Khz ultrasonic range for better propagation) send unique code division sequences (each transmitter has it's own sequence).
Upon receiving the RF marker, each one of the mobile articles uses an internal processor to perform correlation calculations in reference to the three acoustic transmitters.
After performing the correlation, the local maxima processing unit finds N1 local maximum points in the correlation.
These maximum data points are then sent to the base unit using the RF transceiver, (each one of the mobile sensor has it's own time-slot).
The base unit processes the received data, and determines the X-Y-Z location of the mobile sensors.
The location information is then transferred to the PC or Game console.

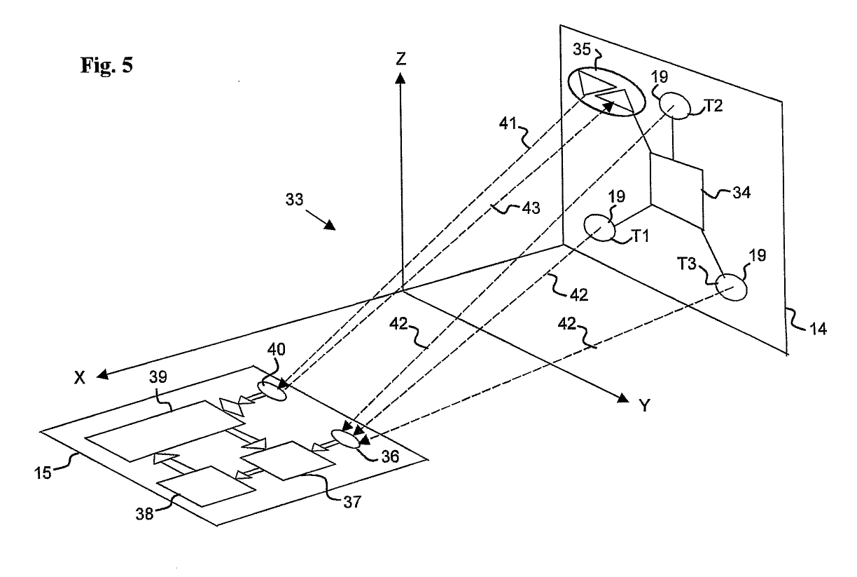

Reference is now made to FIG. 5, which is a simplified schematic illustration of communication channels 33 between the base-unit 14 and the mobile article 15 according to a preferred embodiment of the present invention.

FIG. 5 shows an XYZ axis system within which base-unit 14 and mobile article 15 are positioned. The base-unit 14 includes a processor 34, an RF transceiver 35 and an array of three acoustic transmitters 19 designated as T1, T2 and T3. As seen in FIG. 5, The mobile article 15 preferably contains:
an acoustic receiver 36;
a correlator module 37;
a local maxima processor 38;
a processor 39; and
an RF transceiver 40.

The RF transceiver 35 transmits an RF marker signal 41 (the synchronization signal of FIG. 1). which is received by the transceiver 40 of the mobile article 15. The marker signal 41 enables the mobile article 15 to synchronize. The base-unit 14 transmits three acoustic signals 42 concurrently with the RF marker signal 41. In this way it is possible to calculate the exact Δt_{S1} delay between the arrival at the mobile article 15 of the marker signal 41 and the arrival of the acoustic signal 42 transmitted by acoustic transmitter T1, as well as the exact delays Δt_{S2} and Δt_{S3} for T2 and T3 respectively.

The mobile article 15 receives the acoustic signals 42 and starts to calculate the correlation with the three different sequences transmitted from T1, T2 & T3. Using the power delay profiles the mobile article 15 calculates the required delays and using the RF transceiver 40 the mobile article 15 transmits to the base-unit 14 timing data 43, preferably containing maxima points of the received acoustic signals 42.

Using the timing data 43, the base-unit 14 calculates the 3D location for each mobile article 15. By having three different acoustic signals 42, transmitted by T1, T2 and T3 of the base unit 14, and by having the RF marker signal 41 (zero point in time), the exact time delays between the three acoustic transmitters and the mobile article are estimated.

Denoting the time delays as: Δt₁, Δt₂ and Δt₃, the exact 3D location of the mobile article 15 is estimated. Following is a preferred set of equations demonstrating the computation required:

$$\begin{matrix}Δ {t}_{1} = \frac{\sqrt{{( {x}_{1} - {x}_{s} )}^{2} + {( {y}_{1} - {y}_{s} )}^{2} + {( {z}_{1} - {z}_{s} )}^{2}}}{{V}_{p}} & Eq . 1 \\ Δ {t}_{2} = \frac{\sqrt{{( {x}_{2} - {x}_{s} )}^{2} + {( {y}_{2} - {y}_{s} )}^{2} + {( {z}_{2} - {z}_{s} )}^{2}}}{{V}_{p}} & Eq . 2 \\ Δ {t}_{3} = \frac{\sqrt{{( {x}_{3} - {x}_{s} )}^{2} + {( {y}_{3} - {y}_{s} )}^{2} + {( {z}_{3} - {z}_{s} )}^{2}}}{{V}_{p}} & Eq . 3\end{matrix}$$

Where (xₛ,yₛ,zₛ) are the coordinates of the mobile article 15, and (xₖ,yₖ,zₖ) for k=1,2,3, are the known transmitter coordinates.

$$\begin{matrix}{( Δ {t}_{1} {V}_{p} )}^{2} - {( Δ {t}_{3} {V}_{p} )}^{2} - ( {x}_{1}^{2} + {y}_{1}^{2} + {z}_{1}^{2} ) + ( {x}_{2}^{2} + {y}_{2}^{2} + {z}_{2}^{2} ) = 2 \times ( {x}_{2} - {x}_{1} ) {x}_{s} + 2 ( {y}_{2} - {y}_{1} ) {y}_{s} + 2 ( {z}_{2} - {z}_{1} ) {y}_{s} & Eq . 4 a \\ {( Δ {t}_{1} {V}_{p} )}^{2} - {( Δ {t}_{3} {V}_{p} )}^{2} - ( {x}_{1}^{2} + {y}_{1}^{2} + {z}_{1}^{2} ) + ( {x}_{3}^{2} + {y}_{3}^{2} + {z}_{3}^{2} ) = 2 \times ( {x}_{3} - {x}_{1} ) {x}_{s} + 2 ( {y}_{3} - {y}_{1} ) {y}_{s} + 2 ( {z}_{3} - {z}_{1} ) {y}_{s} & Eq . 4 b \\ {( Δ {t}_{2} {V}_{p} )}^{2} - {( Δ {t}_{3} {V}_{p} )}^{2} - ( {x}_{2}^{2} + {y}_{2}^{2} + {z}_{2}^{2} ) + ( {x}_{3}^{2} + {y}_{3}^{2} + {z}_{3}^{2} ) = 2 \times ( {x}_{3} - {x}_{2} ) {x}_{s} + 2 ( {y}_{3} - {y}_{2} ) {y}_{s} + 2 ( {z}_{3} - {z}_{2} ) {y}_{s} & Eq . 4 c\end{matrix}$$

The above equations can be solved by the following steps:

It is possible to form three linear equations with three unknowns as follows:

$$[ \begin{matrix}{x}_{s} \\ {y}_{s} \\ {z}_{s}\end{matrix} ] = {[ \begin{matrix}2 ( {x}_{2} - {x}_{1} ) & 2 ( {y}_{2} - {y}_{1} ) & 2 ( {z}_{2} - {z}_{1} ) \\ 2 ( {x}_{3} - {x}_{1} ) & 2 ( {y}_{3} - {y}_{1} ) & 2 ( {z}_{3} - {z}_{1} ) \\ 2 ( {x}_{3} - {x}_{2} ) & 2 ( {y}_{3} - {y}_{2} ) & 2 ( {z}_{3} - {z}_{2} )\end{matrix} ]}^{- 1} \cdot [ \begin{matrix}{( Δ {t}_{1} {V}_{p} )}^{2} - {( Δ {t}_{2} {V}_{p} )}^{2} - ( {x}_{1}^{2} + {y}_{1}^{2} + {z}_{1}^{2} ) + ( {x}_{2}^{2} + {y}_{2}^{2} + {z}_{2}^{2} ) \\ {( Δ {t}_{1} {V}_{p} )}^{2} - {( Δ {t}_{3} {V}_{p} )}^{2} - ( {x}_{1}^{2} + {y}_{1}^{2} + {z}_{1}^{2} ) + ( {x}_{3}^{2} + {y}_{3}^{2} + {z}_{3}^{2} ) \\ {( Δ {t}_{2} {V}_{p} )}^{2} - {( Δ {t}_{3} {V}_{p} )}^{2} - ( {x}_{2}^{2} + {y}_{2}^{2} + {z}_{2}^{2} ) + ( {x}_{3}^{2} + {y}_{3}^{2} + {z}_{3}^{2} )\end{matrix} ] \qquad Eq . 4 d$$

In case we use more than 3 transmitters, we can use least square model to get the location of the mobile sensors. We define:

d_{k→m}=(ΔtₖVₚ)²−(ΔtₘVₚ)²−(xₖ²+yₖ²+zₖ²)+(xₘ²+yₘ²+zₘ²) and Eq. 5:

Δx_{→m}=(xₖ−xₘ), Δy_{k→m}=(yₖ−yₘ), Δz_{k→m}=(zₖ−zₘ) Eq. 6:

Then for N sensors at the base unit we have:

$$[ \begin{matrix}{d}_{1 \to 2} \\ ⋮ \\ {d}_{( n - 2 ) \to ( n - 1 )} \\ {d}_{( n - 1 ) \to n}\end{matrix} ] = [ \begin{matrix}2 Δ {x}_{2 \to 1} & 2 Δ {y}_{2 \to 1} & 2 Δ {z}_{2 \to 1} \\ & & \\ 2 Δ {x}_{( n - 1 ) \to ( n - 2 )} & 2 Δ {y}_{( n - 1 ) \to ( n - 2 )} & 2 Δ {z}_{( n - 1 ) \to ( n - 2 )} \\ 2 Δ {x}_{n \to ( n - 1 )} & 2 Δ {y}_{n \to ( n - 1 )} & 2 Δ {z}_{n \to ( n - 1 )}\end{matrix} ] [ \begin{matrix}{x}_{s} \\ {y}_{s} \\ {z}_{s}\end{matrix} ] \\ If \\ H = [ \begin{matrix}2 Δ {x}_{2 \to 1} & 2 Δ {y}_{2 \to 1} & 2 Δ {z}_{2 \to 1} \\ & & \\ 2 Δ {x}_{( n - 1 ) \to ( n - 2 )} & 2 Δ {y}_{( n - 1 ) \to ( n - 2 )} & 2 Δ {z}_{( n - 1 ) \to ( n - 2 )} \\ 2 Δ {x}_{n \to ( n - 1 )} & 2 Δ {y}_{n \to ( n - 1 )} & 2 Δ {z}_{n \to ( n - 1 )}\end{matrix} ] \\ And \\ r = [ \begin{matrix}{d}_{1 \to 2} \\ ⋮ \\ {d}_{( n - 2 ) \to ( n - 1 )} \\ {d}_{( n - 1 ) \to n}\end{matrix} ] \qquad Eq . 7$$

Then, according to the Least Squares solution we have:

$${[ \begin{matrix}{x}_{s} \\ {y}_{s} \\ {z}_{s}\end{matrix} ]}_{LS} = {( H \cdot {H}^{T} )}^{- 1} \cdot {H}^{T} \cdot r \qquad Eq . 8$$

Preferably, the algorithm for estimating the location of the mobile articles works as follows: The RF marker 41 is periodically transmitted by the base-unit 14, setting the t=0 zero time and causing the mobile-articles 15 to initiate localization sessions. Concurrently with the RF marker 41, three acoustic transmitters 19 in the base-unit 14, transmit unique orthogonal acoustic code signals 42. The orthogonal codes enable the mobile-articles 15 to distinguish between the acoustic signals 42.

Upon receiving the RF marker signal 41 at the RF transceiver 40, the mobile-article 15 preferably starts three correlation processes at the correlator 37. The acoustic signals 42 are received by the acoustic receiver 36 and each is processed by one of the correlation processes at the correlator 37, resulting in the power delay profiles.

The internal local maxima processor 38 then preferably determines N1 maxima points (and levels) which are then forwarded to the processor 39 and transmitted as timing data 43 to the base-unit 14, preferably at predetermined time slots.

Upon receiving the maxima points at the transceiver 35, the processor 34 of the base-unit 14, preferably computes a histogram and determines the time delays. Once calculating the time delays, the base-unit 14 computes the location of the mobile-article 15, using Eqs. (1-8) described above.

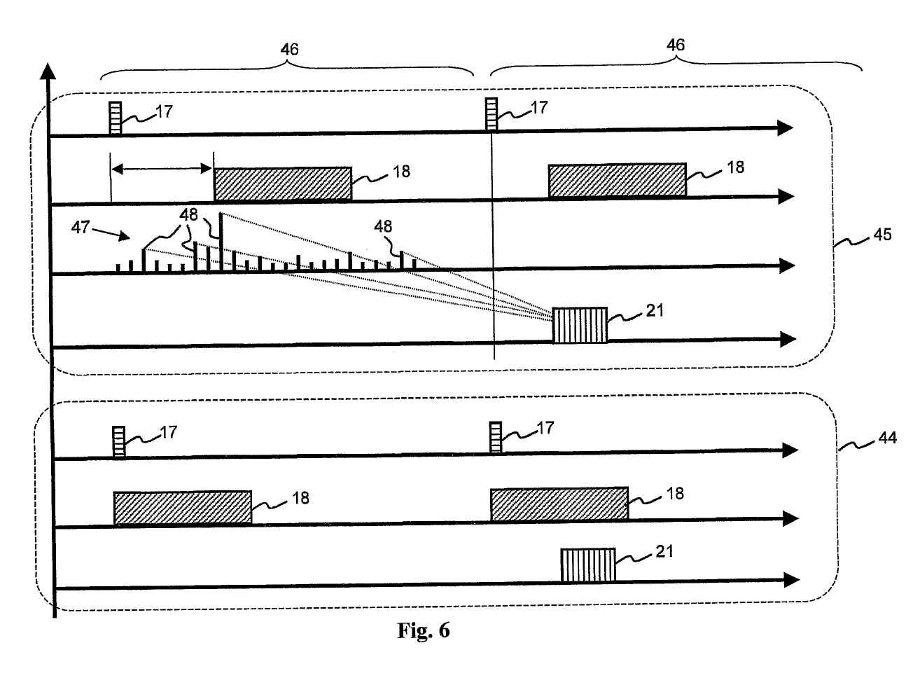

Reference is now made to FIG. 6, which is a simplified timing diagram of RF and acoustic signals flowing within the motion-capture system 13 according to a preferred embodiment of the present invention.

As seen in FIG. 6, the timing diagram of the motion-capture system 13 contains a time diagram 44 of the base-unit 14 and time diagram 45 of the mobile-article 15.

As seen in FIG. 6, the base-unit 14 repeatedly transmits RF marker signals 17, which mark the zero point of a frame cycle 46. Concurrently, the base-unit 14 transmits acoustic signals 18. It is appreciated that acoustic signals 18 are transmitted from a plurality of acoustic transmitters, as shown in FIGS. 1 and 5.

As seen in FIG. 6, the RF marker signals 17 and the acoustic signals 18 are received by the mobile-article 15. The RF marker signals 17 are received almost immediately, while the acoustic signals 18 are received at a delay Δt. Each of the mobile-articles 15, upon receiving the marker signal 17, starts calculating correlation 47 for the unique sequence of each acoustic signal 18. The internal maxima processor 38 located in the mobile-articles 15 finds the best N1, maxima points 48.

Preferably in the next frame cycle, the mobile-article 15 transmits the timing data, preferably containing the maxima points, back to the base-unit 14, preferably at a specific time slot, using its RF transceiver 40 (see FIG. 5). The base-unit 14 further uses this timing data to calculate the exact 3D location for the respective mobile-article 15, relative to the location of the base-unit 14.

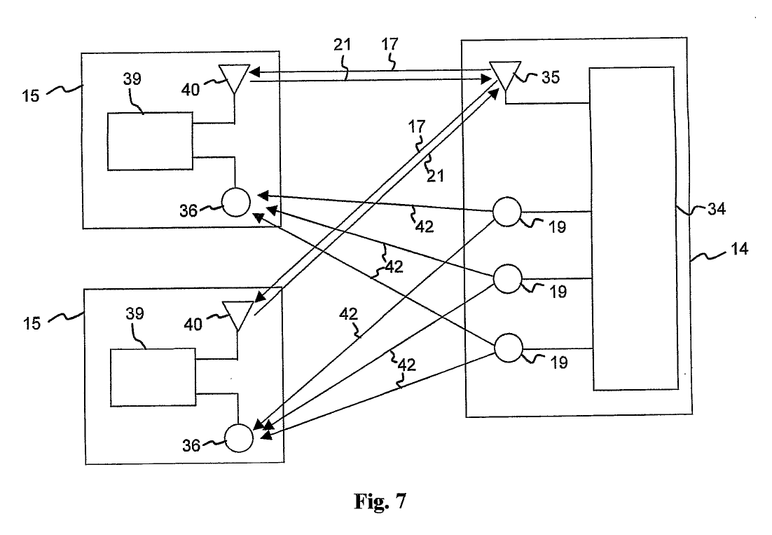

Reference is now made to FIG. 7, which is a simplified schematic diagram of the motion-capture system 13 equipped with a plurality of mobile-articles 15, according to a preferred embodiment of the present invention.

As seen in FIG. 7, the base-unit 14 serves two mobile-articles 15. The base-unit 14 preferably includes a processor 34, an RF transceiver 35, and three acoustic transmitters 19. Each of the mobile-articles 15 preferably includes a processor 39, an RF transceiver 40 and acoustic receiver 36 (other components, as shown in FIG. 5, are not shown in FIG. 7 for simplicity).

The base-unit 14 preferably use the acoustic transmitters 19 for transmitting periodical synchronization signals 17, to the mobile-articles 15, and for receiving timing data 21 preferably containing path delay information from the mobile-articles 15. The base-unit 14 preferably use the array of acoustic transmitters 19 (at least three) for transmitting acoustic signals 42, used for the computation of the locations of the mobile-articles 15.

The mobile-articles 15 preferably use their transceivers 40 for receiving the synchronization signals 17 and for transmitting timing data, preferably containing the path delays information. The mobile-articles 15 preferably use their acoustic receivers 36 for receiving the acoustic signals 42. The mobile-articles 15 preferably use their processors 39 for correlation computation for identifying the respective path delays.

In accordance with the example of FIG. 7, the operation of the motion-capture system 13 is based on a “processing frame cycle” in which the base-unit 14 sends RF and acoustic signals to the mobile-articles 15, receives RF signals from the mobile-articles 15 in “Time Division Multiple Access” (TDMA) multiplexing, and determines the location of each mobile-articles 15.

The processing frame cycle is preferably 1 msec, which is chosen to support accuracy better then 1 cm. In each frame the base-unit 14 transmits synchronized synchronization signals 17 and acoustic signals 42, and the mobile-articles 15 send timing data 21 computed for the synchronization signals 17 and acoustic signals 42 of the previous frame.

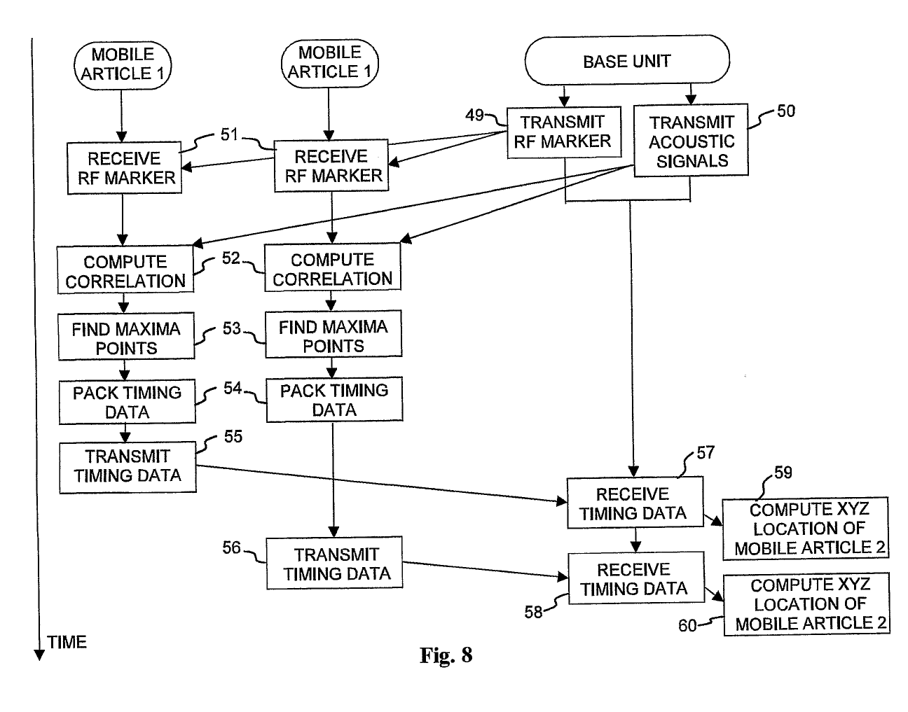

Reference is now made to FIG. 8, which is a simplified flowchart of an operation scenario of the motion-capture system 13, according to a preferred embodiment of the present invention.

The flowchart of FIG. 8 shows a typical cycle of operation executed by the motion-capture system 13. The cycle begins with step 49, when the base-unit 14 transmits RF synchronization signal (time marker) 17. The synchronization signal 17 initiates one processing cycle. The RF marker is used to mark a zero point (start time) for the time when the base-unit 14 transmits at least three acoustic signals 42 (step 50). The complete processing frame cycle typically takes 1 msec. Each processing frame cycle begins with an RF marker, and in parallel to the RF marker acoustic signals are transmitted by the acoustic array transmitters of the base station.

The multiplexing scheme for the acoustic signals transmitted by the base unit is the code division, which allows separation between the different acoustic signals.

The mobile-articles 15, upon receiving the RF marker 17 (steps 51), starts the correlation process in (steps 52) order to find the power delay profile. Preferably, the mobile-articles 15 finds maxima points (steps 53) and pack them into timing data 21 (steps 54). The mobile-articles 15 then send the timing data 21 to the base-unit 14 within their respective time-slots (steps 55 and 56).

The base-unit 14 then preferably receives the timing data 21 (steps 57 and 58) and computes the XYZ location of the mobile-articles 15 (steps 59 and 60).

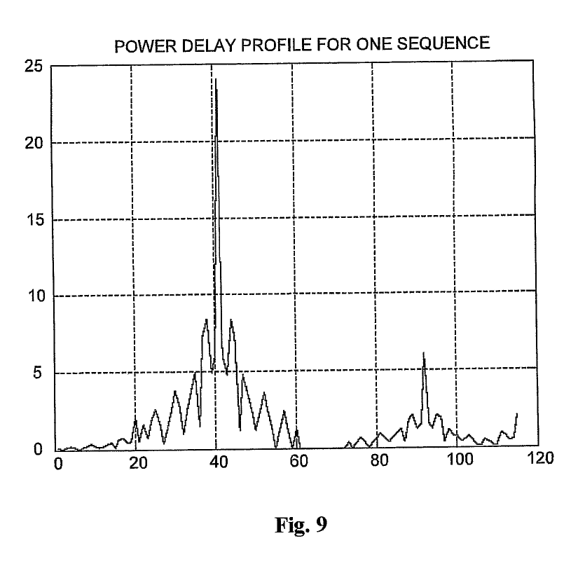

Reference is now made to FIG. 9, which is a simplified diagram of power delay profile for a frame of the motion-capture system 13, according to a preferred embodiment of the present invention.

FIG. 9 shows the power delay profile for one sequence. Each mobile-articles 15 performs the correlation process for each of the unique acoustic sequence transmitted by the acoustic transmitters 19 of the base-unit 14. In general, at least 3 acoustic transmitters 19 are needed, causing at least 3 power delay profiles to be calculated.

To achieve an omni-directional acoustic reception in the mobile-articles 15 (for best results), each mobile-articles 15 is equipped with an array of up to ten acoustic receivers. Therefore, each one of the mobile-articles 15 needs to compute the power delay profile for each of the received sequences, resulting in the calculation of up to 30 power delay profiles in each time frame. It is appreciated that the power delay profile is computed for each one of the acoustic receivers 36 and then the power delay profile information is processed. In order not to loose information, no beam-forming is done, rather, the system performs the complete processing chain for each one of the acoustic receivers 36.

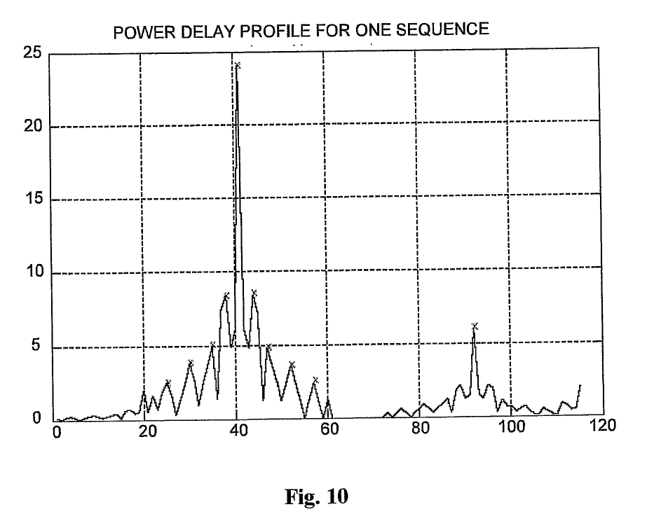

Reference is now made to FIG. 10, which is a simplified diagram of power delay profile showing maxima points, according to a preferred embodiment of the present invention. In the example of FIG. 10 there is an extraction of 10 maxima points.

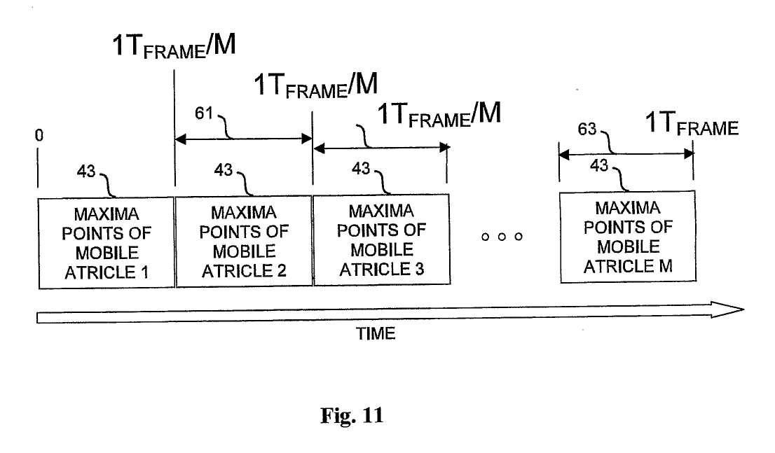

Reference is now made to FIG. 11, which is a simplified schematic diagram of a time division multiple access (TDMA) process for transmitting timing data 21, according to a preferred embodiment of the present invention.

The TDMA process of FIG. 11 functions as follows: Each mobile-articles 15 is operative to pack the maxima location points and values in time, and to transmit the packed information (timing data) using its RF wireless transceiver, back to the base station. The method of using the RF channel to transmit the maxima points to the base unit is Time Division Multiple Access (TDMA). Starting from the marker synchronization points, and assuming M mobile sensors, the first mobile-articles 15 out of M mobile-articles 15 transmits its timing data 43 at time slot [0,Tframe/M] (61). The second mobile-articles 15 transmits its timing data 43 at time slot [Tframe/M] (62). The third mobile-articles 15 transmits its timing data 43 at time slot [2Tframe/M] (63), and so on.

Since the operation of transmitting the maxima points occur at the same time of the correlation process, the maxima points that are transmitted at time frame N, represent the sensors locations at time frame N-1. Prior to the transmission, the maxima points data, are further compressed in order to decrease the transmission time and therefore to decrease the RF transmitter power consumption. This process repeats endlessly for every processing frame.

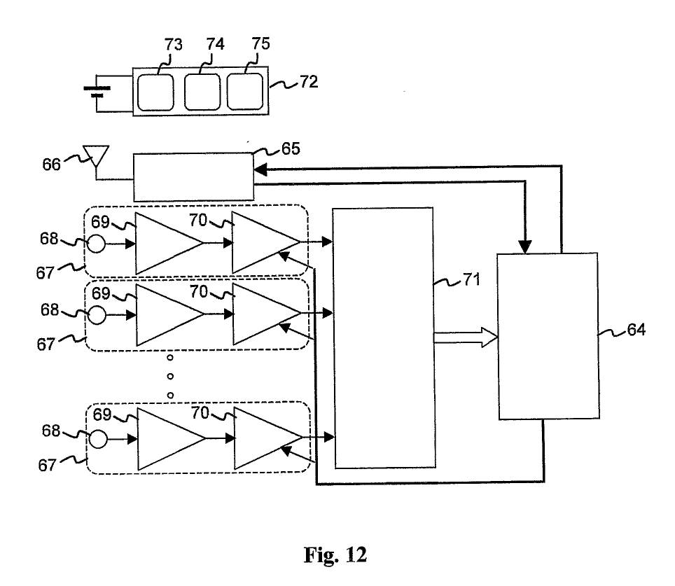

Reference is now made to FIG. 12, which is simplified block-diagram illustration of a mobile-article 15 according to a preferred embodiment of the present invention.

It is appreciated that in the case of 40 Khz acoustic frequency, the amount of MIPS required for the power delay profile and maxima points computation is rather low. Therefore, a preferred embodiment of mobile sensor is based on a Digital Signal Processor (DSP).

As seen in FIG. 12, the mobile-article 15 preferably includes the following components:
a processor 64, preferably a digital signal processor (DSP);
an RF transceiver 65 and antenna 66;
a plurality of acoustic chains 67, each preferably containing:
   an acoustic transducer 68;
   an acoustic pre-amplifier and filters module 69; and
   a programmable gate array (PGA) 70 implementing a programmable gain amplifier;
an analog to digital array 71;
a power supply manager 72, preferably containing the following parts:
   a motion sensor 73 responsible for shutting down the power supply once the mobile sensor is not moving for a time-out period;
   a time-out counter 74 for measuring the time-out period; and
   a DC/DC converter 75, which includes:
      power supply for the acoustic receivers;
      power supply for the RF transceiver;
      power supply for pre-amplifiers and programmable gain amplifiers of the acoustic chain, and for the DSP.

The RF transceiver 65 is preferably responsible for receiving marker signals, generating interrupts to the DSP, and transmitting the maxima points information (timing data).

For power saving, while the RF transceiver 65 is not operating, it is shut down by the power supply manager 72, along with the acoustic transducers 68, pre-amplifiers 69, and PGA 70.

The DSP 64 is preferably responsible for the pre-processing of the acoustic signals and for performing the required amplification. The amplification blocks are required in order to bring the acoustic received signal to the right level when sampled by the analog to digital converter (ADC) array.

It is appreciated that the range of the signals received from the acoustic sensors after the pre-amplifier, is around 0.1 mv-10 mv. This means that if the system needs to bring the signal to 100 mv for the ADC, the PGA needs a gain of 10-1000. To achieve that the hardware can use the TI INA128 which has 8 nv/sqrt(Hz) noise—meaning that for 100 Khz sampling rate the noise would be 2.52 uv (which is well below the 100 uv signal level of the acoustic sensor, which gives SNR of 32 dB).

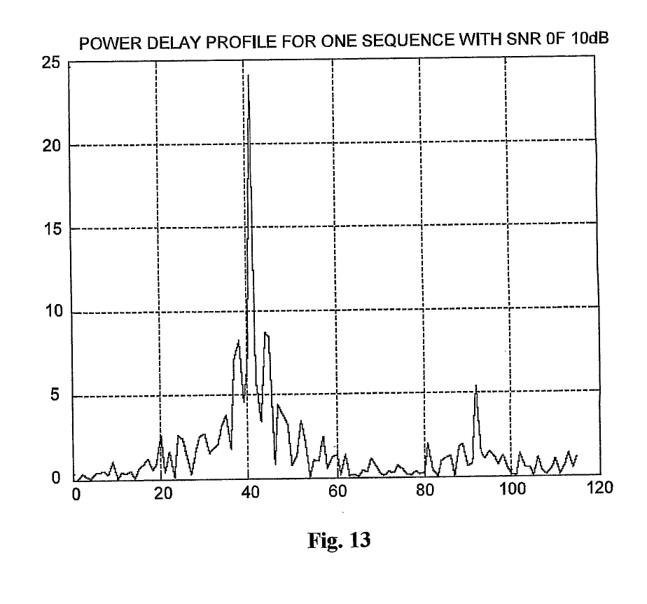

Reference is now made to FIG. 13, which is a simplified diagram of a power delay profile in a motion-capture system 13, according to a preferred embodiment of the present invention

FIG. 13 shows the power delay profile under the assumption of one sequence of SNR of 10 dB. It is appreciated that the analog to digital converter array 71 of FIG. 12 is based on 10 ADC's of 10-12 bits resolution. For that purpose, we can use TI ADS7829, which is 12 bits ADC @125Ksamples/sec with extremely low power of 0.6 mwatts. In total, the ADC array consumes 6 mwatts. The DSP, from TI (320VC5510A), works at a frequency of 200 Mhz, and consumes (400 Milion macs) 112 ma @1.6 volts=179 mwatts.

Following is a calculation of the power versus the amount of MIPS required:

One correlation at 100 Khz with 20 taps, gives 2 Milion macs. 30 Correlations give 60 Milions macs, amounting to 30 MIPS. Search for maxima 1000 points gives (1000+3000)×1000=4 MIPS. Search for 30 Power Delay Profile gives 120 MIPS. Total MIPS therefore amounts to 150 MIPS. The DSP has 400 MIPS which means that 150 MIPS will consume about 179 mwatts*150/400=67 mwatts. Amplifiers (each 100 ua) give 2 ma×5 v=10 mwatts. The result is that the total power by the Mobile Sensor=83 mwatts.

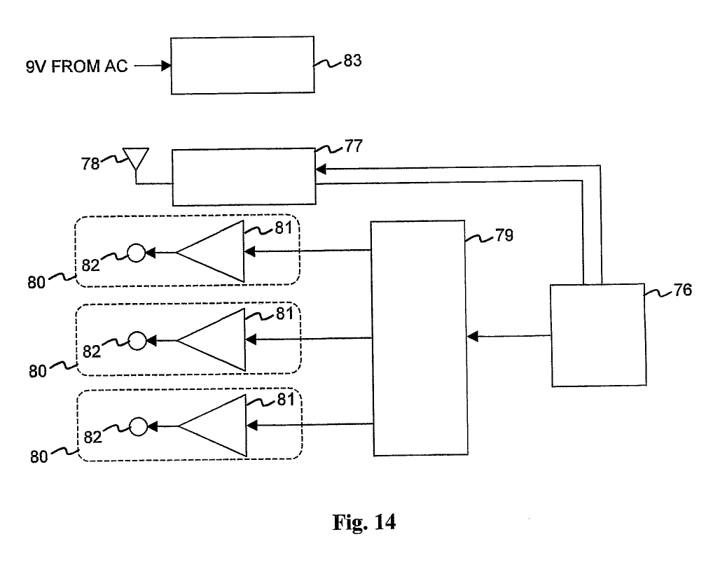

Reference is now made to FIG. 14, which is a simplified block-diagram illustration of a base-unit 14 according to a preferred embodiment of the present invention.

As seen in FIG. 14, the base-unit 14 preferably includes:
a processor 76, preferably a digital signal processor (DSP);
an RF transceiver 77 and antenna 78;
interface 79 connecting to acoustic channels 80;
acoustic channels, preferably three or more, each containing an analog buffer 81 and an acoustic transmitter 82;
a power supply 83.

An example of the hardware design of FIG. 14 includes acoustic transducers from SenseComp (www.senscomp.com). For the transmitters: 40KT08 model and for the receivers: 40KR08 model. According to the data sheets of the transducers, at 30 cm distance we have 0.0002 ubar, therefore at 3 meters (20 dB attenuation) we would have 0.00002 ubar. Meaning, that we would have about 20 uvolts at the receiver. After a gain of 1000 using the INA128—with a BPF of 40 Khz, we would result with about 20 mvolts. With a BW of 40 Khz we would have the following noise levels:

Noise_level=sqrt(40000 Hz)*8 nv/sqrt(Hz)=1.6 uv

This means that the SNR at the output of the pre-amplifier would be 21 dB.

Using the power delay profile that was tested with simulation at SNR of 10 dB, we will now calculate the maximum distance of operation. For that we need to determine the minimum SNR for the power delay profile.

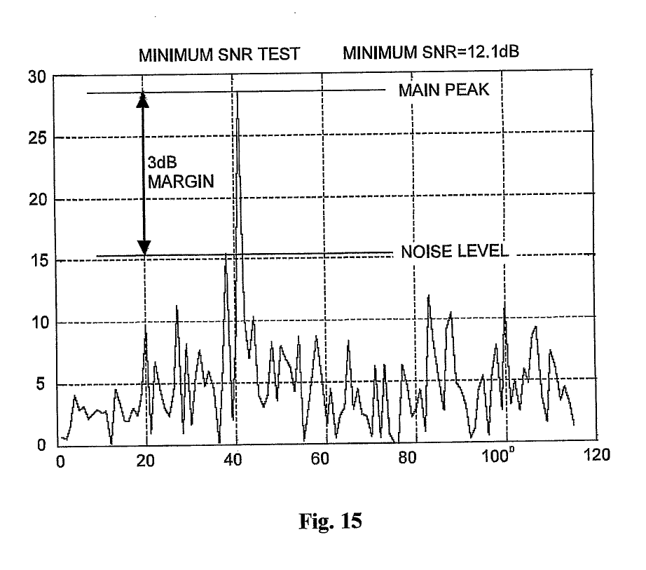

Reference is now made to FIG. 15, which is a diagram of a minimum SNR power delay profile according to a preferred embodiment of the present invention.

FIG. 15 shows the minimum SNR under the assumption of at least 3 dB margin (twice) between the peak and the noise level. The minimum required SNR is about −12.1 dB. With a noise of 1.6 uv, this implies a signal level of 0.4 uv.

Preferably, the design of the motion-capture system 13 complies with sensitivity requirement of −80 dB. With the current scenario, the signal level is well above the acoustic receiver sensitivity threshold level, which is −20 db, and therefore bigger then the required −80 db. This implies that the motion-capture system 13 can operate at distance rage of at least three meters. It may be appreciated that the SNR performance is enhanced due to the fact that the system uses code division for the acoustic transmission.

An Application Specific Integrated Circuit (ASIC) for the motion-capture system is now described. The motion-capture system 13 described above requires: 30 Milion MACS for the power delay profiles; 120 Milion×2 subtracts for the maxima points. Assuming 90 nm LP process from TSMC, it is possible to support 3 nwatts/MHz/Gate dynamic power and 60 nwatts/Gate leakage power.

16 bits by 16 bits multiplier requires about 4Kgates, which amounts to 30 Milion MACS, which would require about 120 G Gates/sec or: Power delay profile dynamic power=120000*3 nwatts=360 uwatts; Power Delay Profile leakage power (assuming 100 Mhz clock)=1200*60 nwatts=7.2 uwatts. this amounts to a Total Power Delay Profile=0.367 mwatts.

For the search the system requires 120 Milion×2 additions=240 Milions. Each addition is 16 bits wide. Where each Full-Adder is 5 gates, thus we have 1.2 G Gates/Sec which is a small figure compared to the Power Delay Profile needs.

Therefore, the power delay profile will consume about 0.4 mwatts.

Each ADC consumes 0.6 mwatts giving 6 mwatts. Amplifiers consumes about 100 ua each giving 2 ma*5 v=10 mwatts. The RF receiver consumes about 20 mwatts. However, the transceiver in our system is operated at only 10% of the time, therefore it will consume 2 mwatts (the receiver is switched ON, shortly prior to the expected point of detection). Summation of the total power would result with: Expected power of 20.4 mwatts, when using an ASIC.

It is appreciated that for the motion-capture system 13 described above the following is applicable:
Using the method and diagrams of the RF transceiver and the Acoustic localization unit, the mobile article does not need to transmit high power acoustic signals. Therefore the power consumption of the mobile articles is greatly reduced.
The mathematical theory provides proof of concept for the proposed system design.
Using histograms, there is a solution also for hidden paths.
The system design provides a method to achieve an enhanced Omni-directional acoustic reception using a low cost array of 40 Khz acoustic sensors.
The system design would further reduce the power consumption, by using ON/OFF switching for the RF transceiver.
There is no need to receive synch signals every 1 msec. The mobile article will first acquire synchronization point and then correct itself every 10 or 20 msec. This method will result with the reducing of the RF receiver power consumption, to 5%-10% of normal operation.
RF transmission is done using TDMA, resulting with simplification and power reduction. The transmitter will be ON only at 10% of the time.

Applying compression algorithm to compress packs of maxima points (similar to AR process), will result with further decreasing the transmission time and the power consumption of the mobile articles.

It is also appreciated that the TI 320VC5510 DSP provides a possible embodiment for the system (base-units and mobile-articles) which will simplify the design process.

A localization method in accordance with a preferred embodiment of the present invention is now described. A localization method is preferably provided and employed in accordance with a motion capture system which might be identical to the motion-capture system 13 described above.

To synchronize the system, the base-unit transmits an RF marker every 1 msec, which is used as a zero marker. During this time, the base-unit, using acoustic transmitter T1, T2 & T3, transmits different acoustic sequences. As described above with reference to FIG. 5, the acoustic signal is received immediately in the 1 msec cycle. This means that for 1 msec we would allow a range of 1 msec×343 m/sec=˜0.342 m. This range is insufficient for home use, considering room size is about 4×4×2.5 meters. Therefore, reflections of up to 2\sqrt{4²+4²+2.5²}=12.3 m may occur. This implies that the delay spread of the acoustic reflection would be about

$$\frac{12.3}{343} = 36 m sec .$$

Hence, a special mechanism to calculate the location every 1 msec and support delay spread of up to 36 msec is required.

To fulfill these requirements it is necessary to perform the following:
Send synchronization markers every time slot>36 msec (preferably 50 msec), This RF synchronization marker will be used to adjust the internal PLL (this is to allow some loss or false positive detection of synchronization signals); and
Send an acoustic signal every 1 msec with length<14 msec=(50−36). However, transmission of sequences with length>1 msec, will, in fact, increase the total cost of our system. This is since the acoustic transmitter in this case, will need three Digital to Analog (DAC) converters, instead of a simple pulse transmission.

To solve this issue, the base-unit 14 preferably sends sequences with a length of 1 msec, which result in a total of 50 sequences. The mobile article, has to detect these 50 sequences. To enable the mobile-article 15 to distinguish between the sequences, the base-unit 14 transmits code division based sequences.

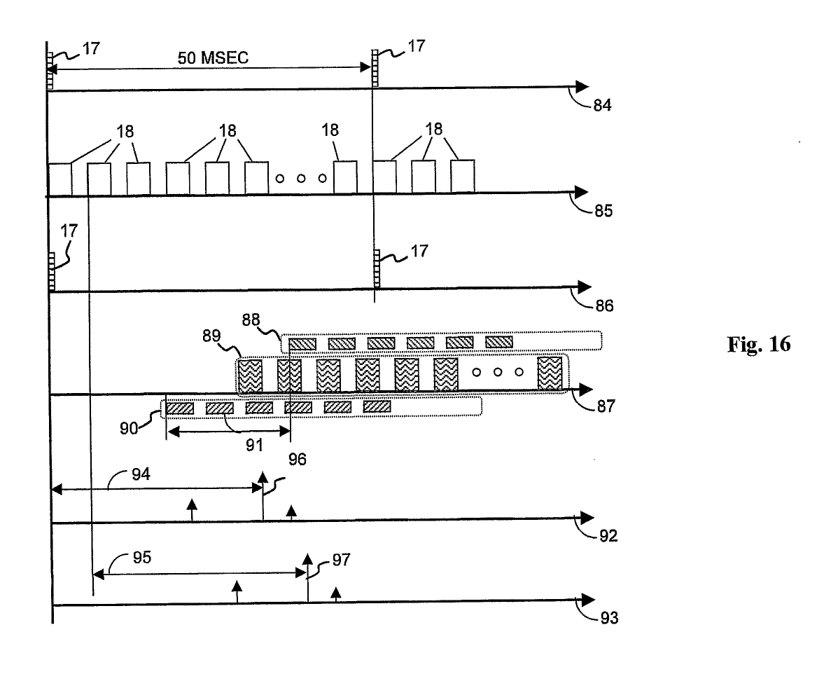

Reference is now made to FIG. 16, which is a simplified time-flow of a sequence transmission in the motion-capture system 13, according to a preferred embodiment of the present invention.

FIG. 16 shows an example of 50 acoustic code-based sequences transmitted by the base-unit 14 and received by the mobile-article 15.

Timeline 84 shows the transmission, by the transceiver 35 of the base-unit 14, of RF synchronization signals 17 every 50 msec. Timeline 85 shows the transmission, by one of the three acoustic transmitters 19 of the base-unit 14, of an acoustic sequence of 50 acoustic signals 18. Each of the acoustic signals 18 is modulated with a 20-30 chips code division sequence orthogonal (uncorrelated) to other sequences.

Timeline 86 shows the RF synchronization signals 17 received at the mobile-article 15. Timeline 87 shows the acoustic sequence received at the mobile-article 15 including a main-path 88 and two side-paths 89 and 90. Timeline 87 also shows the delay spread 91 for the first sequence.

Timelines 92 and 93 show the time delays 94 and 95, for the first and the second sequences, respectively. As shown, the time delays 94 and 95 are measured to the selected paths 96 and 97, respectively.

As the RF synchronization signal 17 is received by the mobile-article 15, the mobile article starts calculating the time delays. The calculation starts from the arrival of the synchronization signal 17. As shown below, the delay to the first sequence is measured from the time the RF synchronization signal 17 is received by the mobile-article 15. The delay to the second code division sequence, is measured from 1 msec after the RF synchronization signal 17 is received by the mobile-article 15.

The mobile-article 15 starts calculating the power delay profile for each of the, 50 sequences (for each transmission antenna and for each acoustic receiver). This results in total: A_{TX}A_{RX}50 Power delay profiles to compute, wherein A_{RX},A_{TX} are the number of acoustic receivers 36 mobile-article 15 multiplied by the number of transmitters.

It is appreciated that for a system with (at least) 3 acoustic transmitters 19 and 4 acoustic receivers 36, there are 3×4×50=600 Power delay profiles to compute. Upon computing the correlations, the correlations are preferably transmitted during the next frame period, preferably in synchronization with the RF synchronization signal 17.

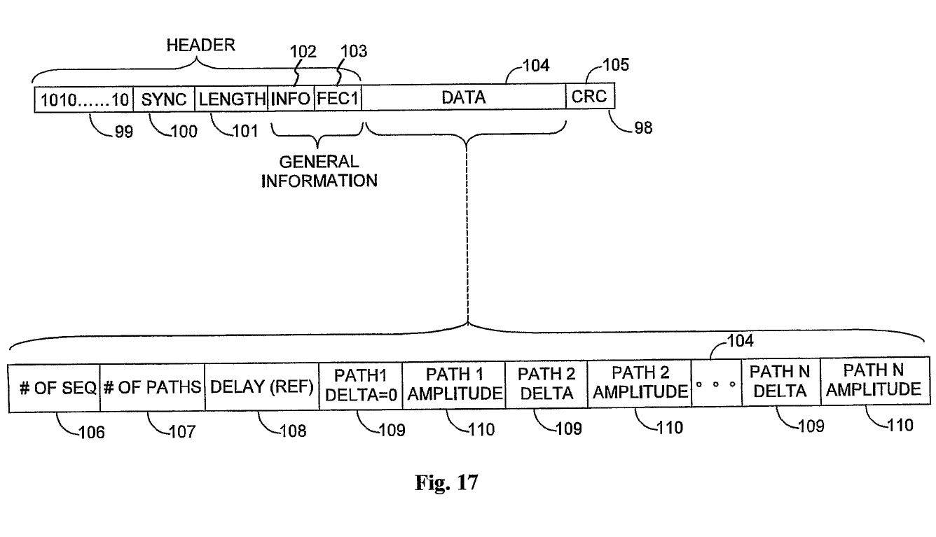

Reference is now made to FIG. 17, which is a simplified block diagram of the timing data 21, according to a preferred embodiment of the present invention.

As seen in FIG. 17, the a packet 98 of the timing data 21 preferably contains:
serial communication clock signal “1010 . . . 10” of 16 bits (element 99);
sync word, preferably “11110000”, 8 bits (element 100);
the length of the packet in bytes, preferably 8 bits (element 101);
information 102 and RS FEC data 103, which is 4 bytes+4 bytes;
data (element 104), which contains the path delays information: and
CRC (element 105) or similar.

The data portion of the packet preferably contains the following elements:
sequence number (0-49) (1 Byte) (element 106);
number of paths (1-3) (1 Byte) (element 107);
delay reference, 2 bytes (MAX DELAY=100 msec), resolution=0.1/2̂16=1.5 usec. (element 108);
path information (3 bytes), repeated per the number of paths, preferably containing:
   Path Delta time, the time measured from the reference delay to the path data (2 bytes), (element 109);
   Path amplitude (1 byte), (element 110).

The above RF message transmission is preferably repeated for every code sequence. The transmission is preferably arranged in TDMA time frames.

The system preferably uses 21 Bytes=168 bits, per each one of the code division sequences. While taking into account a total of one acoustic receiver; 3 acoustic transmitters; and 5 mobile articles.

The system typically requires an RF wireless channel of at least: 168×3×5×50×20=2.52 Mbits/Sec

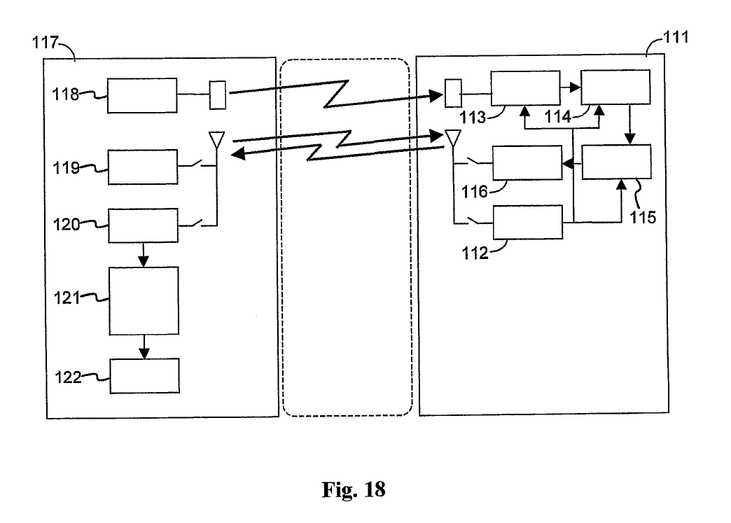

Reference is now made to FIG. 18, which is a simplified block diagram of a localization algorithm performed by the motion-capture system 13 according to a preferred embodiment of the present invention.

The high level algorithm of FIG. 18 includes the following algorithms:
Algorithms performed by the acoustic mobile-article module 111, including:
   Synchronization, using RF signal, preferably performed by the RF receiver module 112;
   AGC, for acoustic signal, done every 50 msec, correlations, and selection of the best three paths, for every code sequence, preferably performed by modules 113 and 114;
   packing and framing the data for transmission back to the base unit for localization (module 115); and transmission back to the ABU (module 116).
Algorithms performed by the base-unit module 117 including:
   transmission of RF synchronization signal, preferably every 50 msec (module 118);
   transmission of 3×50 un-correlated code division sequences (by three acoustic transmitters) concurrently with the synchronization signal (module 119);
   receiving the timing data (module 120),
   selecting best path using histogram, and deciding the location of each one of the mobile articles (DSP module 121);
   sending the calculated location to the PC application (USB module 122).

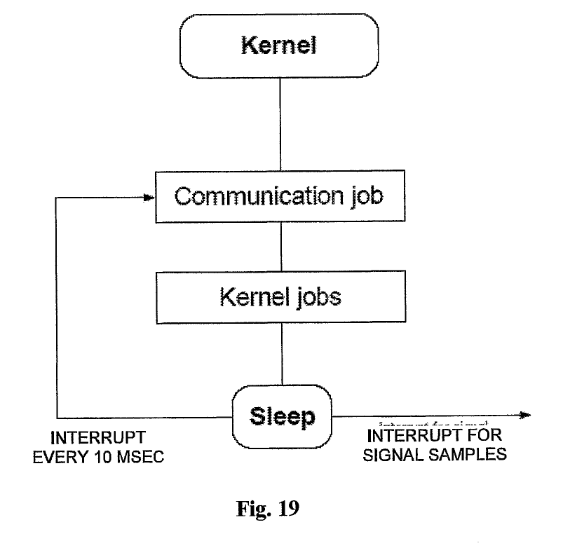

Reference is now made to FIG. 19, which is a simplified flowchart of a background procedure of the mobile-article 15 according to a preferred embodiment of the present invention

FIG. 19 describes a kernel software module of the mobile-article 15, which is a background loop, being executed every 10 msec to perform shut down and communication for testing and/or debugging the mobile-article 15.

It is appreciated that the kernel is used as a background for shutdown control and preferably other kernel jobs, such as a watchdog, communication etc.

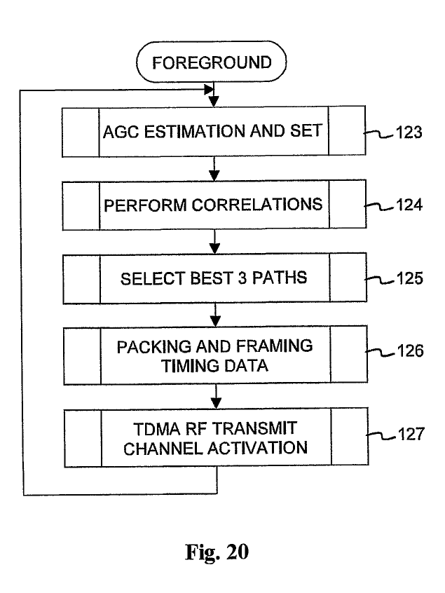

Reference is now made to FIG. 20, which is a simplified flowchart of a foreground procedure of the mobile-article 15 according to a preferred embodiment of the present invention

The foreground procedure of FIG. 20 preferably includes the following subroutines:
Automatic Gain Control (subroutine 123).
Correlation (subroutine 124).
Path selection (subroutine 125).
Framing (subroutine 126).
Activation of the RF transmitter (subroutine 127).

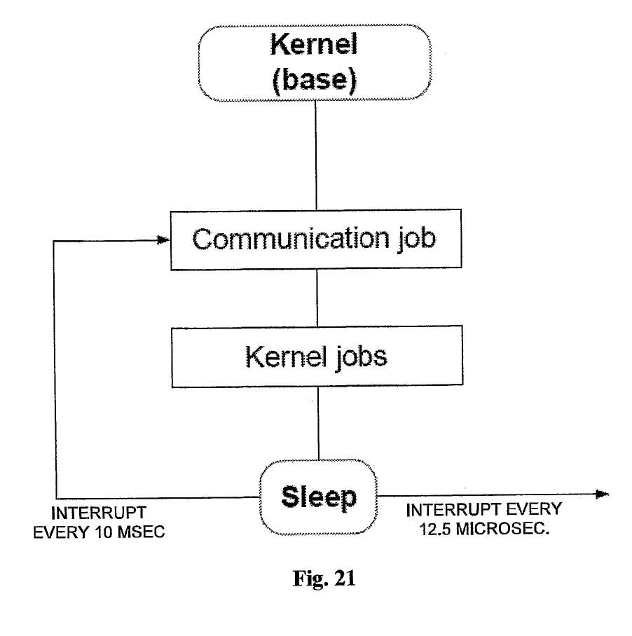

Reference is now made to FIG. 21, which is a simplified flowchart of a background procedure of the base-unit 14 according to a preferred embodiment of the present invention.

FIG. 21 describes a kernel software module of base unit 14, which is executed in the background and is responsible for testing communications, watchdog procedures, and for similar kernel jobs.

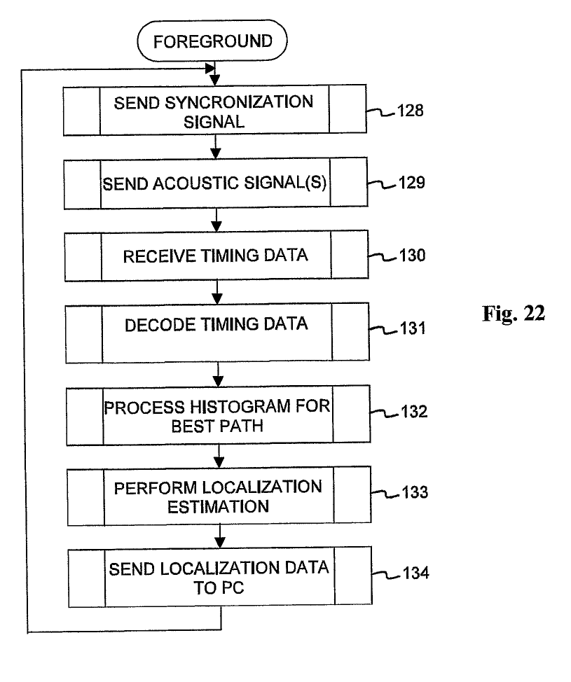

Reference is now made to FIG. 22, which is a simplified flowchart of a foreground procedure of the base-unit 14 according to a preferred embodiment of the present invention.

FIG. 22 describes the foreground procedure of the base-unit 14, which is executed periodically, preferably at a resolution of 12.5 usec, typically in accordance with the resolution of mobile-article 15. The foreground procedure of the base-unit 14 include the following subroutines, which are responsible for their respective functions:
Transmission of RF signal for synchronization (subroutine 128).
Transmission of acoustic signal for localization (subroutine 129).
Receive and decode the RF back channel messages (subroutines 130 and 131).
Perform the localization (subroutines 132 and 133), preferably using Eq(4) and Eq(8) described above.
Send the localization data to the host computer (subroutine 134).

It is expected that during the life of this patent many relevant motion-capture devices and systems will be developed and the scope of the terms herein, particularly of the terms “acoustic” and “RF”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A motion-capture base-unit for detecting a motion-capture mobile-article, said base-unit comprising:
two or more acoustic transmitters, each operative for transmitting an acoustic signal;
an RF transmitter operative to transmit a synchronization signal; and
an RF receiver operative to receive timing data transmitted from said mobile-article,
wherein
said synchronization signal and said acoustic signals are transmitted synchronously, and
said timing data contains time measuring information associated with time delay at said mobile-article between said synchronization signal and said acoustic signals.

2. The motion-capture base-unit according claim 1 additionally comprising a communication unit operative to connect said base-unit with a computer.

3. The motion-capture base-unit according claim 1 wherein the timing data contains a plurality of maxima points of said acoustic signals measured at said mobile-article.

4. The motion-capture base-unit according claim 2 wherein said communication unit comprises at least one of a wired communication technology and a wireless communication technology.

5. The motion-capture base-unit according claim 2 wherein said base-unit is operative to communicate motion-capture information of said mobile-article via said communication unit to said computer.

6. The motion-capture base-unit according claim 5 wherein said motion-capture information comprises at least one of:
location of at least one of said mobile-articles;
orientation of at least one of said mobile-articles;
motion direction of at least one of said mobile-articles;
motion speed of at least one of said mobile-articles;
status information of said actuating key of at least one of said mobile-articles; and
location of said base-unit.

7. The motion-capture base-unit according claim 6 wherein said motion-capture information comprises three-dimensional data.

8. A motion-capture mobile-article for detecting said mobile-article with respect to a base-unit, the mobile-article comprising:
at least one acoustic receiver, each operative for receiving an acoustic signal transmitted from said base-unit;
an RF receiver operative to receive a synchronization signal transmitted from said base-unit; and
an RF transmitter operative to transmit timing data to said base-unit,
wherein
said synchronization signal and said acoustic signals are transmitted synchronously, and
said timing data contains time measuring information associated with time delay at said mobile-article between said synchronization signal and said acoustic signals.

9. The motion-capture mobile-article according claim 8 wherein said detection of said article comprises at least one of: location, orientation, motion direction and motion speed of said mobile-article.

10. The motion-capture mobile-article according to claim 8 additionally comprising:
a correlator module operative to identify said acoustic signals;
a local maxima processor operative to identify maxima points of said received acoustic signals; and
a processor for creating timing data.

11. The motion-capture mobile-article according to claim 8 additionally comprising:
a digital signal processor (DSP);
a plurality of acoustic chains, each acoustic chain comprising:
an acoustic transducer;
an acoustic pre-amplifier and filters module;
a programmable gain amplifier; and
an analog to digital array.

12. The motion-capture mobile-article according to claim 8 additionally comprising:
a power supply manager comprising:
a motion sensor for shutting down power supply once said mobile article is still for a time-out period; and
a time-out counter for measuring said time-out period.

13. The motion-capture mobile-article according to claim 8 wherein said article is attached to a human subject and wherein said base station is operative to detect at least one of: location, orientation, motion direction and motion speed of said human subject.

14. The motion-capture mobile-article according to claim 8 wherein said article is attached to a body part of a human subject and wherein said base station is operative to detect at least one of: location, orientation, motion direction and motion speed of said mobile body part of human subject.

15. The motion-capture mobile-article according to claim 14 wherein said article additionally comprises a strap to be fastened to said body-part.

16. The motion-capture mobile-article according to claim 8 wherein said article additionally comprises at least one actuating key, and wherein said timing data additionally comprise status information of said actuating key.

17. The motion-capture mobile-article according to claim 16 wherein said actuating key comprises an electric switch.

18. The motion-capture mobile-article according to claim 16 and operative as at least one of:
a joystick;
a computer's pointing device; and
as a remote control for at least one of a television and a set-top-box.

19. The motion-capture mobile-article according to claim 18 and operative to perform at least one of:
effect menu selection; and
animate a visual object.

20. The motion-capture mobile-article according to claim 8 wherein said timing data comprises correlation of said acoustic signal.

21. The motion-capture mobile-article according to claim 8 wherein said timing data is calculated from, or comprises, a sequence of a predefined number of maxima points of said acoustic signals.

22. The motion-capture mobile-article according to claim 21 wherein said predefined number of maxima points is based on multiplication of Atx by Arx, wherein Atx is the number of said acoustic transmitters, and wherein Arx is the number of said acoustic receivers.

23. The motion-capture mobile-article according to claim 8 wherein said timing data is sent to said base-unit for each acoustic signal received from each acoustic transmitter, and wherein the timing data is transmitted sequentially using Time Division Multiple Access (TDMA).

24. The motion-capture mobile-article according to claim 8 wherein said timing data is sent to said base-unit for each acoustic signal received from each acoustic transmitter, and wherein the timing data is transmitted sequentially using TDMA.

25. The motion-capture mobile-article according to claim 24 wherein said timing data comprises forward error correction code (FEC).

26. The motion-capture mobile-article according to claim 25 wherein said FEC comprises Reed-Solomon (RS) code.

27. The motion-capture mobile-article according to claim 8 additionally comprising motion sensor and wherein said mobile-article is operative to switch between operation and stand-by modes according to measurement provided by said motion sensor.

28. The motion-capture base-unit according claim 1 wherein motion-capture information comprises at least one of:
location of at least one of said mobile-articles;
orientation of at least one of said mobile-articles;
motion direction of at least one of said mobile-articles;
motion speed of at least one of said mobile-articles;
status information of said actuating key of at least one of said mobile-articles; and
location of said base-unit.

29. The motion-capture base-unit according to claim 1 wherein said acoustic signals are each coded at the base-unit for identification of the acoustic signal at the mobile-article.

30. The motion-capture base-unit according to claim 29 wherein said coding of said acoustic signals comprises code-division sequences.

31. The motion-capture base-unit according to claim 1 wherein said timing data comprises:
clock signal;
packet length identifier;
forward error correction (FEC) data;
path delays information; and
CRC.

32. The motion-capture base-unit according to claim 31 wherein said path delay information comprises:
path delta time measured from a reference delay to path data; and
path amplitude.

33. A method of motion-capture comprising:
providing a base station performing the steps of
transmitting an RF signal for synchronization,
transmitting a plurality of acoustic signals for localization,
receiving timing data from a mobile-article,
performing localization of said mobile article to form localization data, and
sending said localization data to a host computer.

34. A method of motion-capture comprising:
providing a mobile-article performing the steps of
receiving RF signal transmitted by a base-unit for synchronization,
receiving a plurality of acoustic signals transmitted by said base-unit for localization,
correlating said acoustic signals to identify at least one path of said acoustic signals,
selecting at least one of said paths,
creating timing data packet comprising information of said selected paths, and
transmitting said timing data to said base-unit.
